(19) United States
(12) Patent Application Publication
(10) Pub. No.: US 2003/0017879 A1
(43) Pub. Date: Jan. 23, 2003

(54) Automatic stabilizer for high-speed drill spindle

(76) Inventors: Chun-Yi Tsay, Taoyuan (TW); Yi-Hwa Chen, Taoyuan (TW)

Correspondence Address: TROXELL LAW OFFICE PLLC, 5205 LEESBURG PIKE, SUITE 1404, FALL CHURCH, VA, 22041, US

(21) Appl. No.: 10/190,486

(22) Filed: Jul. 9, 2002

(30) Foreign Application Priority Data
Jul. 23, 2001 (TW) 090211477

(51) Int. Cl. F16C 3/00

(52) U.S. Cl. 464/180

(57) ABSTRACT

An automatic stabilizer for the high-speed drill spindle in which when the rotation speed of the drill spindle is in excess of the natural frequency, the vibration centric momentum goes in the opposite direction of the mass imbalance. While the rotation speed is much higher than the natural frequency, the phase difference between the vibration centric momentum and the mass imbalance. A this instance, the rolling elements are inclined to move to the large radius side, in other word moving in the direction opposite to the mass imbalance so as to offset it to achieve the automatic stability in the drill spindle.

### BACKGROUND OF THE INVENTION

1. Field of the invention

This invention relates to an automatic stabilizer for the high-speed drill spindle, in particular the kind of device which utilizes free rolling elements and automatic stability theory in high speed operation so as to automatically keep the high-speed drill spindle always in stable operation.

2. Description of the Prior Art

The design tendency of the electronic products emphasizes a light, slim, short and mini structure, so the electronic parts assembled in the electronic product becomes increasingly minimized day after day. As the circuit density on the printed circuit board intensifies, the diameter of the drill bit becomes smaller and smaller. In the cutting theory, the diameter of the drill bit is in reverse proportion to the rotary speed of the drill. The diameter of a drill point for boring the PCB is normally less than φ 0.5 mm. The rotary speed of the drill has increased from 40,000 rpm to 150,000 rpm, which is far faster than the general machine tool.

As the rotary speed is extremely high, the requirement of accuracy for the spindle has become stricter than before; in particular in the dynamic balance, the exactly accurate accuracy is a must. Should there be mass imbalance, considerable amount of eccentric centrifugal force would be produced under high speed of rotation, which would cause undesirable vibration. The FIG. 1 and FIG. 2 show the prior art of the drill spindle, comprising a spindle 1, an induction rotor 2, a stabilizing ring 3, a stabilizing hole 4, a pull lever 5, a chuck 6 and a drill 7. The spindle is factory-calibrated before shipping out. FIG. 1 illustrates the proper method of calibration. A stabilizing ring 3 is reserved on a spindle 1. A spindle 1 is set to work at a predetermined high speed and the eccentric momentum is measured to infer where the mass imbalance is located. Based on this measurement, an adequate stabilizing hole 4 is drilled on the side of the stabilizing ring 3 where mass imbalance occurs to offset the mass imbalance. This dynamic calibration of balance is carried out at a fixed speed until the value of vibration is lower than a certain value. Since the centrifugal force (F) of a mass imbalance of a rotary body is directly proportional to the mass, the rotary radius and the square of speed (F=mrω²), it implies that a tiny bit of mass imbalance would produce substantial centrifugal force in the high-speed operation. The calibrated mass balance may work well at a fixed speed, but it will lose balance when the speed increases.

The factory-calibrated spindle requires no further calibration after shipment. But in most cases, as shown in FIG. 2, the spindle has many other accessories to be installed and disassembled. Such installation and disassembly are certain to create some loose tolerance as well as a tiny bit of eccentricity and mass imbalance which are hard to be calibrated. Such mass imbalance occurring in the spindle expedites a fast wear and early replacement.

From the above statements, it is learned that the prior art of the drill spindle owns the following weaknesses:

(1) Fabrication of the parts should be accurate and precise, so the yield rate is low.

(2) The calibration of dynamic balance is one by one not an easy job, and the calibration instrument for high speed is very expensive.

(3) The tolerance of the parts must be under strict control or the eccentricity should be removed in the design stage.

(4) The calibrated spindle is workable at a fixed speed, and the vibration is unavoidable when the speed changes.

(5) Tiny wear speeds up a fast damage after long time of use.

(6) Vibration renders damage to the bearing.

As indicated above, the prior art of the drill spindle is defective and requires great improvement.

Having seen the weaknesses the prior art of the drill spindle inheres, the inventor has devoted years of efforts to the improvement and come up with the stabilizer for the high-speed drill spindle as presented in this invention.

### SUMMARY OF THE INVENTION

In order to eliminate the weaknesses the prior art of the drill spindle has, an automatic balance theory of the rolling element is applied to maintain automatic balance of the drill spindle when working at a high speed with the minimum vibration.

The object of the invention is to provide an automatic stabilizer, comprising at least one or more stabilizing rings concentric to the shaft of the drill spindle. The stabilizing ring provides a hollow orbit course in the center to receive two or more rolling elements. The rolling elements are free balls or rollers. The rolling elements are moving and rotating along the external wall of orbit course of the stabilizing ring. When the momentum of the centrifugal force the rolling elements produce in the movement is greater than or equal to the total centrifugal force all components of the drill spindle caused due to the mass imbalance, the automatic stability is achieved.

### BRIEF DESCRIPTION OF THE DRAWINGS

FIG. 1 is a schematic diagram of the prior art of the drill spindle.

FIG. 2 is a schematic diagram of the assembly of the prior art of the drill spindle.

FIG. 3 shows the frequency influence diagram.

FIG. 4 is a schematic diagram of the drill spindle of the invention.

FIG. 5 is a plan of the drill spindle in operation (the spindle in balance)

FIG. 6 is a plan of the drill spindle in operation (the spindle in minor imbalance)

FIG. 7 is a plan of the drill spindle in operation (the spindle in major imbalance)

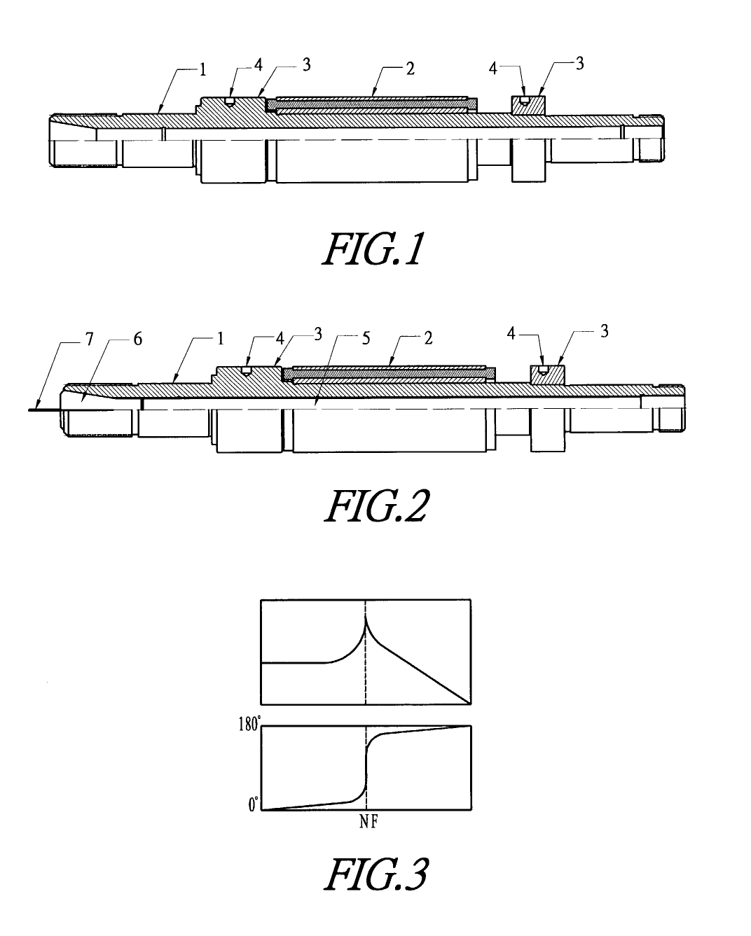

### DETAILED DESCRIPTION OF THE PREFERRED EMBODIMENT

The high-speed spindle, if its mass is not evenly distributed, would produce centrifugal force and imbalance in the rotation. The higher the speed, the severer the vibration is, which affects the precision of work piece and leads to damage of the machine.

The automatic stabilizer designed in this invention is to operate the high-speed drill spindle in which the speed is in excess of the natural frequency.

(1) The relationship between the eccentric momentum and the mass imbalance in the rotary mechanism. As shown in FIG. 3, at the low speed, the eccentric momentum and the mass imbalance are in same direction. As the speed increases, the eccentric momentum lags one phase behind the mass imbalance; while the speed exceeds the natural frequency, the phase angle enlarges rapidly at the opposite direction and close to 180° as the speed continues to increase. That is to say the rotary radius of the mass imbalance at one side reduces in size and on the contrary, the rotary radius at other side grow larger.

(2) The rolling elements in the rotary mechanism are inclined to move to the large radius side due to the centrifugal force.

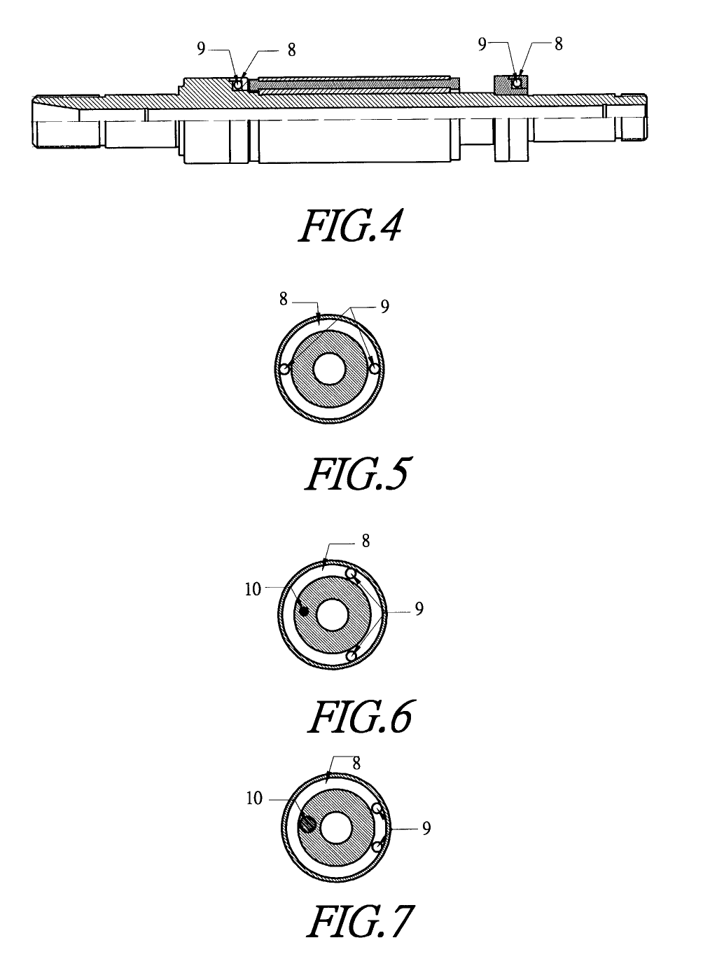

As shown in FIG. 4, the drill spindle is outfitted with one or more stabilizing rings 3 concentric to the shaft of the spindle. Each stabilizing ring has a circular hollow orbit course 8 permitting the rolling elements 9 to roll and rotate along the external wall of orbit course. Each stabilizing ring contains two or more rolling elements 9 freely rolling in the orbit course. The rolling elements are balls or rollers.

As shown in FIG. 5, when in operation and the spindle 1 it is balanced, the rolling elements 9 are even dispersed along the circular hollow orbit course 8. If the spindle has a mass imbalance 10 as shown in FIG. 6 and FIG. 7, at the moment when the speed is excess of the natural frequency, the spindle 1 will swing to the opposite direction of the mass imbalance 10. At this instance, the radius of the spindle 1 becomes smaller on the mass imbalance 10 side, and a large radius appears on the opposite side of the mass imbalance 10. The rolling elements 9 in the circular hollow orbit course 8 will be brought to roll and rotate by the friction force to synchronize with rotation of the spindle 1. The rotation produces centrifugal force, so the rolling elements 9 roll along the external wall of the circular hollow orbit course 8. Due to the action of the centrifugal force, the rotary radius of the rolling elements is greater than directional movement; it is an act to counter the mass imbalance. When the total of the mass centrifugal forces of the rolling elements 9 is greater than the total of centrifugal force created by the mass imbalance of the spindle 1, the rolling elements 9 will generate a divided angle to offset the mass imbalance 10 inherited to the spindle 1. That implies that the mass centrifugal force generated in the rolling elements is larger than or equal to the centrifugal force caused by the mass imbalance of the spindle 1, the automatic balance is achieved. The greater the centrifugal force the rolling elements produce, the larger the divided angle will be.

The eccentric vibration of the mass imbalance 10 is employed to produce the radius difference so the automatic stability is obtained. The higher the rotary speed, the less the centric vibration is and more obvious the automatic stability will be. For the prior art of the drill spindle, vibration goes in proportion to the speed.

The stabilizer for the high-speed drill spindle excels the prior art of the drill spindle in the following advantages:

(1) The precision in spindle manufacture is alleviated, less production cost and high yield rate.

(2) It requires no balance calibration, no purchase of expensive calibration instrument.

(3) It reduces the adverse influence other factors render, so the vibration of the drill spindle is reduce to the minimum.

(4) The speed requirement for the drill spindle is on the way to increase, and the vibration declines, this is the proper way to develop the future drill spindle.

Many changes and modifications in the above described embodiment of the invention can, of course, be carried out without departing from the scope thereof. Accordingly, to promote the progress in science and the useful art, the invention is disclosed and in intended to be limited by the scope of the appended claims.

What is claimed is:

1. An automatic stabilizer for a high-speed drill spindle, at least comprising one stabilizing ring concentric to said spindle, said stabilizing ring having a hollow circular hollow orbit course to receive a plurality of rolling elements, said rolling elements employed to achieve automatic stability in high-speed rotation.

2. The automatic stabilizer for a high-speed drill spindle of claim 1, wherein one or more stabilizing rings are installed on said spindle.

3. The automatic stabilizer for a high-speed drill spindle of claim 1, wherein said rolling elements are free rotating balls or rollers.

4. The automatic stabilizer for a high-speed drill spindle of claim 1, wherein there are two or more rolling elements rotating along an external wall of a circular hollow orbit course to produce centrifugal force greater than total centrifugal force caused by mass imbalance of spindle parts to achieve automatic stability.
